(19) United States
(12) Patent Application Publication
(10) Pub. No.: US 2022/0104486 A1
(43) Pub. Date: Apr. 7, 2022

(54) METHODS OF CONTROLLING OR PREVENTING INFESTATION OF CORN PLANTS BY PHYTOPATHOGENIC MICROORGANISMS

(71) Applicant: SYNGENTA CROP PROTECTION AG, Basel (CH)

(72) Inventor: Matthias GABERTHUEEL, Basel (CH)

(73) Assignee: SYNGENTA CROP PROTECTION AG, Basel (CH)

(21) Appl. No.: 17/425,119

(22) PCT Filed: Jan. 20, 2020
(86) PCT No.: PCT/EP2020/051306

§ 371 Date: Jul. 22, 2021

(30) Foreign Application Priority Data
Jan. 23, 2019 (EP) 19153280.3

(51) Int. Cl. A01N 43/40; A01P 3/00

(52) U.S. Cl. CPC A01N 43/40; A01P 3/00

(57) ABSTRACT

The present invention relates to methods for controlling or preventing infestation of corn plants by phytopathogenic microorganisms of the Fusarium genus, in particular Fusarium Pseudograminearum, Fusarium graminearum and Fusarium culmorum, comprising applying to a crop of plants, the locus thereof, or propagation material thereof, a compound according to formula (I), wherein R1, R2, R3, R4, R5, Y, A, B are as defined herein.

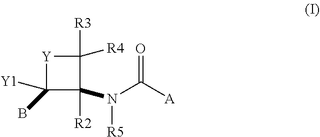

### TECHNICAL FIELD

The present invention relates to methods for controlling or preventing infestation of corn plants by phytopathogenic microorganisms of the Fusarium genus, in particular Fusarium pseudograminearum, Fusarium graminearum and Fusarium culmorum.

### BACKGROUND

Fusarium graminearum is a fungal disease that may affect a number of crops such as wheat, barley, oats, rye, corn and most grass species. The disease is prevalent all over the world. F. graminearum is only one of many species of Fusarium, but it is considered the most important one because of the impact it has on yield and grain quality, its ability to produce several different toxins and its ability to infect the plant during many stages of growth.

Fusarium graminearum is also known by a number of different names such as: head blight, headlight of maize, scab of maize, root rot of maize, stalk rot of maize, ear rot of maize, gibberella stalk rot, gibberella ear rot, red ear rot, pink ear rot, Fusarium root and stalk rot, cobweb disease, malformation disease, tombstone in wheat and scab in wheat.

Thus, the current invention provides further methods for controlling or preventing infestation of corn plants by phytopathogenic microorganisms of the Fusarium genus, in particular Fusarium pseudograminearum, Fusarium graminearum and Fusarium culmorum.

### DESCRIPTION OF THE EMBODIMENTS

Cyclobutylcarboxamide compounds and processes for their preparation have been disclosed in WO2013/143811 and WO2015/003951. It has now been surprisingly found that particular cyclobutylcarboxamide compounds disclosed in WO2013/143811 and/or WO2015/003951 are highly effective at controlling or preventing the infestation of corn plants by phytopathogenic microorganisms of the Fusarium genus, in particular Fusarium pseudograminearum, Fusarium graminearum and Fusarium culmorum. These highly effective compounds thus represent an important new solution for farmers to control or prevent diseases originating from phytopathogenic microorganisms of the Fusarium genus, in particular Fusarium pseudograminearum, Fusarium graminearum and Fusarium culmorum, in corn plants.

Hence, as embodiment 1, there is provided a method of controlling or preventing infestation of corn plants by phytopathogenic microorganisms of the Fusarium genus, more particularly Fusarium pseudograminearum, Fusarium graminearum and Fusarium culmorum, comprising applying to a crop of plants, the locus thereof, or propagation material thereof, a compound according to formula (I)

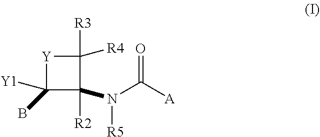

wherein

Y is O, C═O, or CR12R13;

A is a 5- or 6-membered heteroaromatic ring containing 1 to 3 heteroatoms, each independently selected from oxygen, nitrogen and sulphur, or a phenyl ring; the heteroaromatic ring or the phenyl being optionally substituted by one or more R6;

R6 is, independently of each other, halogen, cyano, C1-C4-alkyl, C1-C4-haloalkyl, C1-C4-alkoxy, C1-C4-haloalkoxy, C1-C4-haloalkylthio, C1-C4-alkoxy-C1-4-alkyl or C1-C4-haloalkoxy-C1-C4-alkyl; R1, R2, R3, R4, R12 and R13, independently of each other, are hydrogen, halogen, cyano, C1-C4-alkyl, C1-C4-alkoxy or C1-C4-haloalkyl,

R5 is hydrogen, methoxy or hydroxyl,

B is phenyl substituted by one or more R8,

R8 is, independently of each other, halogen, cyano or a group -L-R9, where each L is independently of each other a bond, —O—, —OC(O)—, —NR7-, —NR7CO—, —NR7S(O)n-, —S(O)n-, —S(O)nNR7-, —COO— or CONR7-,

n is 0, 1 or 2,

R7 is hydrogen, C1-C4-alkyl, C1-C4-haloalkyl, benzyl or phenyl, where benzyl and phenyl is unsubstituted or substituted with halogen, cyano, C1-C4-alkyl or C1-C4-haloalkyl,

R9 is, independently of each other, C1-C6-alkyl, which is unsubstituted or substituted by one or more

R10, C3-C6-cycloalkyl, which is unsubstituted or substituted by one or more R10, C6-C14-bicycloalkyl, which is unsubstituted or substituted by one or more R10, C2-C6-alkenyl, which is unsubstituted or substituted by one or more R10, C2-C6-alkynyl, which is unsubstituted or substituted by one or more R10, phenyl, which is unsubstituted or substituted by R10, or heteroaryl, which is unsubstituted or substituted by one or more R10,

R10 is, independently of each other, halogen, cyano, C1-C4-alkyl, C1-C4-haloalkyl, C1-C4-alkoxy, C1-C4-haloalkoxy, C1-C4-alkylthio, C1-C4-haloalkylthio, C3-C6-alkenyloxy, or C3-C6-alkynyloxy; or a salt or N-oxide thereof;

wherein B and A-CO—NR5 are cis to each other on the four-membered ring,

or a tautomer or stereoisomer of these compounds.

More preferred methods according to embodiment 1 are given in the embodiments below.

As embodiment 2, there is provided a method according to embodiment 1 wherein

Y is O or CH2;

A is a 6-membered heteroaromatic ring containing 1 to 2 nitrogen atoms, or a phenyl ring; the heteroaromatic ring or the phenyl being optionally substituted by one or more R6;

R6 is, independently of each other, halogen, cyano, C1-C4-alkyl, C1-C4-haloalkyl, or C1-C4-haloalkoxy;

R1, R2, R3, R4, and R5 are each hydrogen;

B is phenyl substituted by one or more R8;

R8 is, independently of each other, selected from halogen, cyano, C1-C4-alkyl, C1-C4-haloalkyl, C1-C4-haloalkoxy and C3-C6-cycloalkyl.

As embodiment 3, there is provided a method according to either embodiment 1 or embodiment 2 wherein A is a 6-membered heteroaromatic ring containing 1 to 2 nitrogen atoms and having 1 to 3 substituents selected from R6, or a phenyl ring having 1 or 3 substitutents selected from R6.

As embodiment 4, there is provided a method according to any one of embodiments 1 to 3 wherein B is a phenyl substituted by 1 to 3 substitutents R8.

As embodiment 5, there is provided a method according to any one of embodiments 1 to 4 wherein B is a phenyl substituted by 1 to 3 substituents, independently selected from fluoro, chloro, trifluoromethyl, cyclopropyl, difluoromethoxy and trifluoromethoxy;

A is a phenyl, pyridyl or pyrazinyl, which rings, independently of each other, are unsubstituted or substituted by 1 to 3 substituents, independently selected, from chloro, bromo, fluoro, methyl, cyano, and trifluoromethyl, Y is O or CH2, and R1, R2, R3, R4 and R5 are each hydrogen.

As embodiment 6, there is provided a method according to any one of embodiments 1 to 5 wherein

Y is CH2;

B is a mono or di-halogen substituted phenyl;

A is selected from phenyl, pyrazinyl and pyridyl, each of which is mono or di-substituted by substituents independently selected from halogen and C1-C4-haloalkyl;

R1, R2, R3, R4 and R5 are each hydrogen.

Compounds of formula (I) as disclosed in any one of embodiments 1 to 6 represent the cis racemate: the phenyl ring on the left hand side and the A-C(═O)—NH group on the right hand side are cis to each other on the cyclobutyl ring:

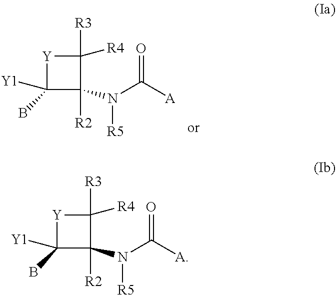

Thus, the racemic compound of formula (I) is a 1:1 mixture of the compounds of formula (Ia) and (Ib). The wedged bonds shown in the compounds of formula (Ia) and (Ib) represent absolute stereochemistry, whereas the thick straight bonds such as those shown for the compounds of formula (I) represent relative stereochemistry in racemic compounds.

It has also surprisingly been found that one enantiomer of the compounds of formula (I) is particularly useful in controlling or preventing infestation of corn plants by phytopathogenic microorganisms of the Fusarium genus, in particular Fusarium pseudograminearum, Fusarium graminearum, Fusarium avenaceum and Fusarium culmorum.

Thus, as embodiment 7, there is provided the method according to embodiment 1 wherein the compound is of formula (Ia)

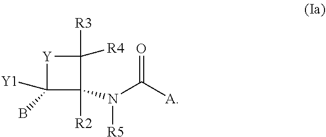

A skilled person is aware that according to the method of embodiment 1, the compound of formula (Ia) is generally applied as part of a pesticidal composition. Hence, as embodiment 8, there is provided a method of controlling or preventing infestation of corn plants by phytopathogenic microorganisms of the Fusarium genus, in particular Fusarium pseudograminearum, Fusarium graminearum and Fusarium culmorum, comprising applying to a crop of plants, the locus thereof, or propagation material thereof a pesticidal composition comprising a compound as defined in any one of embodiments 1-7 and one or more formulation adjuvants. As embodiment 9, there is provided a method of controlling or preventing infestation of corn plants by phytopathogenic microorganisms of the Fusarium genus, in particular Fusarium pseudograminearum, Fusarium graminearum and Fusarium culmorum, comprising applying to a crop of plants, the locus thereof, or propagation material thereof a pesticidal composition comprising a compound of formula (Ia) and one or more formulation adjuvants. In a method according to embodiment 9, for pesticidal compositions comprising both a compound of formula (Ia) and a compound of formula (Ib), the ratio of the compound of formula (Ia) to its enantiomer (the compound of formula (Ib)) must be greater than 1:1. Preferably, the ratio of the compound of formula (Ia) to the compound of formula (Ib) is greater than 1.5:1, more preferably greater than 2.5:1, especially greater than 4:1, advantageously greater than 9:1, desirably greater than 20:1, in particular greater than 35:1.

Mixtures containing up to 50%, preferably up to 40%, more preferably up to 30%, especially up to 20%, advantageously up to 10%, desirably up to 5%, in particular up to 3%, of the trans stereoisomers of the compounds of formula (I) (i.e. wherein the B and the A-C(═O)—NH groups are trans to each other) are also understood to be part of this invention. Preferably, the ratio of the compound of formula (I) to its trans isomer is greater than 1.5:1, more preferably greater than 2.5:1, especially greater than 4:1, advantageously greater than 9:1, desirably greater than 20:1, in particular greater than 35:1.

Preferably, in a composition comprising the compound of formula (Ia), its trans isomer (i.e. wherein the B and the A-CO—NR2 groups are trans to each other) and the compound of formula (Ib), the composition comprises the compound of formula (Ia) in a concentration of at least 50%, more preferably 70%, even more preferably 85%, in particular over 90%, and particularly preferably over 95%, each based on the total amount of compound of formula (Ia), its trans isomer and the compound of formula (Ib).

Further, as embodiment 10, there is provided a method of controlling or preventing infestation of corn plants by phytopathogenic microorganisms of the Fusarium genus, in particular Fusarium pseudograminearum, Fusarium graminearum and Fusarium culmorum, comprising applying to a crop of plants, the locus thereof, or propagation material thereof, a compound according to formula (Ic)

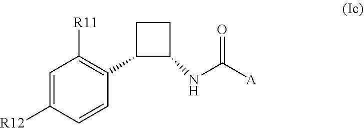

wherein

R11 and R12 are independently selected from halogen;

A is pyridyl which is substituted by one or two substituents independently selected from halogen and C₁-C₄-haloalkyl.

As embodiment 11, there is provided a method according to embodiment 10, wherein

R11 and R12 are independently selected from chloro and fluoro;

A is pyrid-2-yl or pyrid-3-yl, which is substituted by one or two C₁-C₄-haloalkyl substituents.

As embodiment 12, there is provided a method according to embodiments 10 or 11, wherein

A is selected from

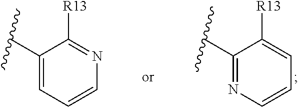

R13 is C₁-C₄-haloalkyl, preferably trifluoromethyl.

As embodiment 13, there is provided a method according to any one of embodiments 10 to 12 wherein the compound is selected from any one of compounds 1 to 7 of formula (Ic)

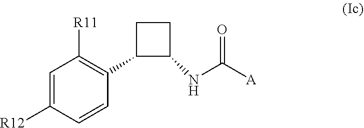

wherein R11, R12 and A are as defined in the following table:

| Compound | A | R11 | R12 |
|---|---|---|---|
| 1 | 2-trifluoromethyl-pyrid-3-yl | Cl | Cl |
| 2 | 3-trifluoromethyl-pyrid-2-yl | Cl | Cl |
| 3 | 3-trifluoromethyl-pyrid-2-yl | F | F |
| 4 | 3-trifluoromethyl-pyrid-2-yl | Cl | F |
| 5 | 3-chloro-pyrid-2-yl | Cl | Cl |
| 6 | 2-methyl-pyrid-3-yl | Cl | Cl |
| 7 | 2-trifluoromethyl-pyrid-3-yl | Cl | F |

As embodiment 14, there is provided the method according to any one of embodiments 1 to 13 comprising the steps
providing a composition comprising a compound as defined in any one of embodiments 1 to 13;
applying the composition to a propagation material;
planting the propagation material.

As embodiment 15, there is provided the method according to any one of embodiments 1 to 13 comprising the steps
providing a composition comprising a compound as defined in any one of embodiments 1 to 13;
applying the composition to a crop of plants or the locus thereof.

As embodiment 16, there is provided the use of a compound as defined in any one of embodiments 1 to 13 for controlling or preventing infestation of corn plants by phytopathogenic microorganisms of the Fusarium genus, in particular Fusarium pseudograminearum, Fusarium graminearum and Fusarium culmorum.

As embodiment 17, there is provided the use of a compound according to embodiment 16 wherein the phytopathogenic microorganism is Fusarium pseudograminearum.

As embodiment 18, there is provided a method for growing corn plants comprising applying or treating corn plants or a propagation material thereof with a compound as defined in any one of claims 1 to 13.

The preparation of the compounds as defined in the methods of any one of embodiments 1 to 13 has been disclosed in WO2013/143811 and WO2015/003951 which are incorporated herein by reference.

### Definitions

The term “halogen” represents fluoro, chloro, bromo or iodo, particularly fluoro, chloro or bromo.

The term “alkyl” or “alk” as used herein either alone or as part of a larger group (such as alkoxy, alkylthio, alkoxycarbonyl and alkylcarbonyl) is a straight or branched chain and is, for example, methyl, ethyl, n-propyl, n-butyl, isopropyl, sec-butyl, isobutyl, tert-butyl, pentyl, iso-pentyl or n-hexyl.

The alkyl groups are suitably C1-C4-alkyl groups.

“Haloalkyl” as used herein are alkyl groups as defined above which are substituted with one or more of the same or different halogen atoms and are, for example, CF₃, CF₂Cl, CF₂H, CCl₂H, FCH₂, ClCH₂, BrCH₂, CH₃CHF, (CH₃)₂CF, CF₃CH₂ or CHF₂CH₂.

The methods and uses according to any one of embodiments 1 to 18 are preferably for controlling or preventing infestation of the crop by phytopathogenic microorganisms of the Fusarium genus, including Fusarium fungi that are resistant to other fungicides. Fusarium fungi that are “resistant” to a particular fungicides refer e.g. to strains of Fusarium that are less sensitive to that fungicide compared to the expected sensitivity of the same species of Fusarium. The expected sensitivity can be measured using e.g. a strain that has not previously been exposed to the fungicide.

Application according to the methods or uses according to any one of embodiments 1 to 18 is preferably to a crop of plants, the locus thereof or propagation material thereof. Preferably application is to a crop of plants or propagation material thereof, more preferably to propagation material. Application of the compounds of the invention can be performed according to any of the usual modes of application, e.g. foliar, drench, soil, in furrow etc.

The compounds as defined in any one of embodiments 1 to 13 are preferably used for pest control at 1 to 500 g/ha, preferably 10-40 g/ha.

The compounds as defined in any one of embodiments 1 to 13 are suitable for use on any corn plant, including those that have been genetically modified to be resistant to active ingredients such as herbicides, or to produce biologically active compounds that control infestation by plant pests.

Generally, a compound as defined in any one of embodiments 1 to 13 is used in the form of a composition (e.g. formulation) containing a carrier. A compound as defined in any one of embodiments 1 to 13 and compositions thereof can be used in various forms such as aerosol dispenser, capsule suspension, cold fogging concentrate, dustable powder, emulsifiable concentrate, emulsion oil in water, emulsion water in oil, encapsulated granule, fine granule, flowable concentrate for seed treatment, gas (under pressure), gas generating product, granule, hot fogging concentrate, macrogranule, microgranule, oil dispersible powder, oil miscible flowable concentrate, oil miscible liquid, paste, plant rodlet, powder for dry seed treatment, seed coated with a pesticide, soluble concentrate, soluble powder, solution for seed treatment, suspension concentrate (flowable concentrate), ultra low volume (ulv) liquid, ultra low volume (ulv) suspension, water dispersible granules or tablets, water dispersible powder for slurry treatment, water soluble granules or tablets, water soluble powder for seed treatment and wettable powder.

A formulation typically comprises a liquid or solid carrier and optionally one or more customary formulaton auxiliaries, which may be solid or liquid auxiliaries, for example unepoxidized or epoxidized vegetable oils (for example epoxidized coconut oil, rapeseed oil or soya oil), antifoams, for example silicone oil, preservatives, clays, inorganic compounds, viscosity regulators, surfactant, binders and/or tackifiers. The composition may also further comprise a fertilizer, a micronutrient donor or other preparations which influence the growth of plants as well as comprising a combination containing the compound of the invention with one or more other biologically active agents, such as bactericides, fungicides, nematocides, plant activators, acaricides, and insecticides.

The compositions are prepared in a manner known per se, in the absence of auxiliaries for example by grinding, screening and/or compressing a solid compound of the present invention and in the presence of at least one auxiliary for example by intimately mixing and/or grinding the compound of the present invention with the auxiliary (auxiliaries). In the case of solid compounds of the invention, the grinding/milling of the compounds is to ensure specific particle size.

Examples of compositions for use in agriculture are emulsifiable concentrates, suspension concentrates, microemulsions, oil dispersibles, directly sprayable or dilutable solutions, spreadable pastes, dilute emulsions, soluble powders, dispersible powders, wettable powders, dusts, granules or encapsulations in polymeric substances, which comprise—at least—a compound as defined in any one embodiments 1 to 13 and the type of composition is to be selected to suit the intended aims and the prevailing circumstances.

As a rule, the compositions comprise 0.1 to 99%, especially 0.1 to 95%, of compound as defined in any one of embodiments 1 to 7 and 1 to 99.9%, especially 5 to 99.9%, of at least one solid or liquid carrier, it being possible as a rule for 0 to 25%, especially 0.1 to 20%, of the composition to be surfactants (% in each case meaning percent by weight). Whereas concentrated compositions tend to be preferred for commercial goods, the end consumer as a rule uses dilute compositions which have substantially lower concentrations of active ingredient.

Examples of foliar formulation types for pre-mix compositions are:
GR: Granules
WP: wettable powders
WG: water dispersable granules (powders)
SG: water soluble granules
SL: soluble concentrates
EC: emulsifiable concentrate
EW: emulsions, oil in water
ME: micro-emulsion
SC: aqueous suspension concentrate
CS: aqueous capsule suspension
OD: oil-based suspension concentrate, and
SE: aqueous suspo-emulsion.

Whereas, examples of seed treatment formulation types for pre-mix compositions are:
WS: wettable powders for seed treatment slurry
LS: solution for seed treatment
ES: emulsions for seed treatment
FS: suspension concentrate for seed treatment
WG: water dispersible granules, and
CS: aqueous capsule suspension.

Examples of formulation types suitable for tank-mix compositions are solutions, dilute emulsions, suspensions, or a mixture thereof, and dusts.

As with the nature of the formulations, the methods of application, such as foliar, drench, spraying, atomizing, dusting, scattering, coating or pouring, are chosen in accordance with the intended objectives and the prevailing circumstances.

The tank-mix compositions are generally prepared by diluting with a solvent (for example, water) the one or more pre-mix compositions containing different pesticides, and optionally further auxiliaries.

Suitable carriers and adjuvants can be solid or liquid and are the substances ordinarily employed in formulation technology, e.g. natural or regenerated mineral substances, solvents, dispersants, wetting agents, tackifiers, thickeners, binders or fertilizers.

Generally, a tank-mix formulation for foliar or soil application comprises 0.1 to 20%, especially 0.1 to 15%, of the desired ingredients, and 99.9 to 80%, especially 99.9 to 85%, of a solid or liquid auxiliaries (including, for example, a solvent such as water), where the auxiliaries can be a surfactant in an amount of 0 to 20%, especially 0.1 to 15%, based on the tank-mix formulation.

Typically, a pre-mix formulation for foliar application comprises 0.1 to 99.9%, especially 1 to 95%, of the desired ingredients, and 99.9 to 0.1%, especially 99 to 5%, of a solid or liquid adjuvant (including, for example, a solvent such as water), where the auxiliaries can be a surfactant in an amount of 0 to 50%, especially 0.5 to 40%, based on the pre-mix formulation.

Normally, a tank-mix formulation for seed treatment application comprises 0.25 to 80%, especially 1 to 75%, of the desired ingredients, and 99.75 to 20%, especially 99 to 25%, of a solid or liquid auxiliaries (including, for example, a solvent such as water), where the auxiliaries can be a surfactant in an amount of 0 to 40%, especially 0.5 to 30%, based on the tank-mix formulation.

Typically, a pre-mix formulation for seed treatment application comprises 0.5 to 99.9%, especially 1 to 95%, of the desired ingredients, and 99.5 to 0.1%, especially 99 to 5%, of a solid or liquid adjuvant (including, for example, a solvent such as water), where the auxiliaries can be a surfactant in an amount of 0 to 50%, especially 0.5 to 40%, based on the pre-mix formulation.

Whereas commercial products will preferably be formulated as concentrates (e.g., pre-mix composition (formulation)), the end user will normally employ dilute formulations (e.g., tank mix composition).

Preferred seed treatment pre-mix formulations are aqueous suspension concentrates. The formulation can be applied to the seeds using conventional treating techniques and machines, such as fluidized bed techniques, the roller mill method, rotostatic seed treaters, and drum coaters. Other methods, such as spouted beds may also be useful. The seeds may be presized before coating. After coating, the seeds are typically dried and then transferred to a sizing machine for sizing. Such procedures are known in the art. The compounds of the present invention are particularly suited for use in soil and seed treatment applications.

In general, the pre-mix compositions of the invention contain 0.5 to 99.9 especially 1 to 95, advantageously 1 to 50% by mass of the desired ingredients, and 99.5 to 0.1, especially 99 to 5, % by mass of a solid or liquid adjuvant (including, for example, a solvent such as water), where the auxiliaries (or adjuvant) can be a surfactant in an amount of 0 to 50, especially 0.5 to 40, % by mass based on the mass of the pre-mix formulation.

The invention will now be illustrated by the following non-limiting Examples. All citations are incorporated by reference.

### Biological Examples

Effect of Different Fungicide Treatments Against Fusarium graminearum in Corn

A corn field trial was carried out in Honeywood, Ontario, Canada, in 2017 to evaluate the efficacy of different compounds against Fusarium graminearum in corn.

Corn seed were treated with different compounds using a slurry volume of 1200 ml per 100 kg of seeds. A fungicide and insecticide base treatment was applied to protect the seeds from the soil diseases Pythium and Rhizoctonia and soil insects like grubs and wireworms.

In order to increase the disease pressure dry inoculum of Fusarium graminearum was placed directly in furrow at planting. The assessment on plant stand (count of plants) was done 36 days after planting on Jun. 20, 2017.

Trial Location:

| Trial Location | Planting Date | Crop | Variety |
|---|---|---|---|
| Honeywood, Ontario, Canada | 15^{th} May, 2017 | Corn | N29t |

Treatment List—Field Trials:

| | | AI Rate | |
|---|---|---|---|
| Treatment | | (mg ai/seed) | Application method |
| 1 | CHECK* | . . . | . . . |
| 2 | COMPOUND 1 FS 500* | 0.3 | Seed treatment |
| 3 | Commercial standard: Succinate | 0.3 | Seed treatment |
| | dehydrogenase inhibitor FS500 | | |
| | (Fluopyram)* | | |

*Base treatment: METALAXYL-M (0.064 mg ai/seed, SEDAXANE (0.016 mg ai/seed), THIAMETHOXAM (0.25 mg ai/seed), CYANTRANILIPROLE (0.25 mg ai/seed)

Crops and Targets Occurred in the Trial:

| | Latin name | Common name |
|---|---|---|
| Target | Fusarium graminearum | Fusarium head blight |
| Crop | Zea mays | Corn |

Crop Description:

| | |
|---|---|
| Test Crop | Corn |
| Variety | N29t |
| Sowing density | 66665 plants/ha (5 plants/m2) |
| Sowing or Planting | 15 May, 2017 |
| Date | |

Trial Layout:

| Trial Environment | Field trial |
|---|---|
| (Test Method) | |
| Experimental Design | Randomized complete block |
| Plot size | 18 m2 |
| # replications | 4 |

Application Details

| | |
|---|---|
| Application Date | 3 May, 2017 |
| Application method | Seed treatment |
| Slurry volume | 1200 ml/100 kg of seeds |

Inoculation Method:

| | |
|---|---|
| Application Date | 15 May, 2017 |
| Pathogen | Fusarium graminearum |
| Inoculation method | Incorporate dry inoculum |
| | in furrow at planting. |
| | The inoculum of Fusarium graminearum |
| | has been produced in the lab using |
| | sorghum seeds as a carrier. |

Assessments:

Plant stand, 36 days after planting (Jun. 20, 2017)

| | | Count plant number | | |
|---|---|---|---|---|
| | | per 12 row meter, | | |
| | | significantly different | % loss of plants | |
| | | (Treatments with no | due to disease | |
| | Active | letter in common are | based on a maximum | % efficacy |
| | Ingredient Rate | significantly different | of 60 plants per 12 | based on loss of |
| Treatment | (mg Al/seed) | at the 5% probability level) | row meters. | plants due to disease |
| CHECK | . . . | 49.17 A | 18.05 | 0 |
| Compound 1 FS 500 | 0.3 | 59.75, B | 0.42 | 97.69 |
| Commercial standard: | 0.3 | 54.58, B | 9.03 | 49.95 |
| Succinate dehydrogenase | | | | |
| inhibitor FS500 (Fluopyram) | | | | |

### CONCLUSION

Compound 1 showed excellent efficacy against Fusarium graminearum with less than 1% loss of plants under high disease pressure. Compound 1 showed an efficacy of over 95%.

The commercial standard, i.e. treatment 3, showed moderate control with an efficacy of 49.95% and 9% loss of plants compared to 18% loss of plants in the check plots.

1. A method for controlling or preventing infestation of corn plants by phytopathogenic microorganisms of the Fusarium genus comprising applying to a crop of plants, the locus thereof, or propagation material thereof, a compound according to formula (I) 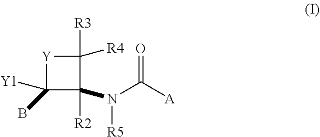
wherein
Y is O, C═O, or CR12R13;
A is a 5- or 6-membered heteroaromatic ring containing 1 to 3 heteroatoms, each independently selected from oxygen, nitrogen and sulphur, or a phenyl ring; the heteroaromatic ring or the phenyl being optionally substituted by one or more R6;
R6 is, independently of each other, halogen, cyano, C1-C4-alkyl, C1-C4-haloalkyl, C1-C4-alkoxy, C1-C4-haloalkoxy, C1-C4-haloalkylthio, C1-C4-alkoxy-C1-4-alkyl or C1-C4-haloalkoxy-C1-C4-alkyl;
R1, R2, R3, R4, R12 and R13, independently of each other, are hydrogen, halogen, cyano, C1-C4-alkyl, C1-C4-alkoxy or C1-C4-haloalkyl,
R5 is hydrogen, methoxy or hydroxyl,
B is phenyl substituted by one or more R8,
R8 is, independently of each other, halogen, cyano or a group-L-R9, where each L is independently of each other a bond, —O—, —OC(O)—, —NR7-, —NR7CO—, —NR7S(O)n-, —S(O)n-, —S(O)nNR7-, —COO— or CONR7-,
n is 0, 1 or 2,
R7 is hydrogen, C1-C4-alkyl, C1-C4-haloalkyl, benzyl or phenyl, where benzyl and phenyl is unsubstituted or substituted with halogen, cyano, C1-C4-alkyl or C1-C4-haloalkyl,
R9 is, independently of each other, C1-C6-alkyl, which is unsubstituted or substituted by one or more R10, C3-C6-cycloalkyl, which is unsubstituted or substituted by one or more R10, C6-C14-bicycloalkyl, which is unsubstituted or substituted by one or more R10, C2-C6-alkenyl, which is unsubstituted or substituted by one or more R10, C2-C6-alkynyl, which is unsubstituted or substituted by one or more R10, phenyl, which is unsubstituted or substituted by R10, or heteroaryl, which is unsubstituted or substituted by one or more R10,
R10 is, independently of each other, halogen, cyano, C1-C4-alkyl, C1-C4-haloalkyl, C1-C4-alkoxy, C1-C4-haloalkoxy, C1-C4-alkylthio, C1-C4-haloalkylthio, C3-C6-alkenyloxy, or C3-C6-alkynyloxy;
or a salt or N-oxide thereof;
wherein B and A-CO—NR5 are cis to each other on the four-membered ring,
or a tautomer or stereoisomer of these compounds.

2. The method according to claim 1 wherein
Y is O or CH2;
A is a 6-membered heteroaromatic ring containing 1 to 2 nitrogen atoms, or a phenyl ring; the heteroaromatic ring or the phenyl being optionally substituted by one or more R6;
R6 is, independently of each other, halogen, cyano, C1-C4-alkyl, C1-C4-haloalkyl, or C1-C4-haloalkoxy;
R1, R2, R3, R4, and R5 are each hydrogen;
B is phenyl substituted by one or more R8;
R8 is, independently of each other, selected from halogen, cyano, C1-C4-alkyl, C1-C4-haloalkyl, C1-C4-haloalkoxy and C3-C6-cycloalkyl.

3. A method according to claim 1 wherein A is a 6-membered heteroaromatic ring containing 1 to 2 nitrogen atoms and having 1 to 3 substituents selected from R6, or a phenyl ring having 1 or 3 substitutents selected from R6.

4. The method according to claim 1 wherein wherein B is a phenyl substituted by 1 to 3 substitutents R8.

5. The method according to claim 1 wherein B is a phenyl substituted by 1 to 3 substituents, independently selected from fluoro, chloro, trifluoromethyl, cyclopropyl, difluoromethoxy and trifluoromethoxy;
A is a phenyl, pyridyl or pyrazinyl, which rings, independently of each other, are unsubstituted or substituted by 1 to 3 substituents, independently selected, from chloro, bromo, fluoro, methyl, cyano, and trifluoromethyl, Y is O or CH2, and R1, R2, R3, R4 and R5 are each hydrogen.

6. The method according to claim 1 wherein
Y is CH2;
B is a mono or di-halogen substituted phenyl;
A is selected from phenyl, pyrazinyl and pyridyl, each of which is mono or di-substituted by substituents independently selected from halogen and C1-C4-haloalkyl;
R1, R2, R3, R4 and R5 are each hydrogen.

7. The method according to claim 1, wherein the compound is a compound of formula (Ic) 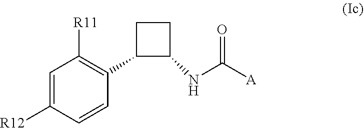
wherein
R11 and R12 are independently selected from halogen;
A is pyridyl which is substituted by one or two substituents independently selected from halogen and C₁-C₄-haloalkyl.

8. The method according to claim 7 wherein
R11 and R12 are independently selected from chloro and fluoro;
A is pyrid-2-yl or pyrid-3-yl, which is substituted by one or two C₁-C₄-haloalkyl substituents.

9. The method according to claim 1 wherein
A is selected from 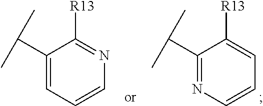
R13 is C₁-C₄-haloalkyl.

10. The method according to claim 1 wherein the compound is selected from any one of compounds 1 to 7 of formula (Ic) 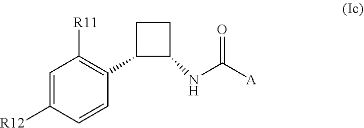
wherein R11, R12 and A are as defined in the following table:

| Compound | A | R11 | R12 |
|---|---|---|---|
| 1 | 2-trifluoromethyl-pyrid-3-yl | Cl | Cl |
| 2 | 3-trifluoromethyl-pyrid-2-yl | Cl | Cl |
| 3 | 3-trifluoromethyl-pyrid-2-yl | F | F |
| 4 | 3-trifluoromethyl-pyrid-2-yl | Cl | F |
| 5 | 3-chloro-pyrid-2-yl | Cl | Cl |
| 6 | 2-methyl-pyrid-3-yl | Cl | Cl |
| 7 | 2-trifluoromethyl-pyrid-3-yl | Cl | F |

11. The method according to claim 1 wherein the phytopathogenic microorganism is Fusarium pseudograminearum, Fusarium graminearum and Fusarium culmorum.

12. The method according to claim 1 wherein the phytopathogenic microorganism is Fusarium graminearum.

13. Use of a compound as defined in claim 1 for controlling or preventing infestation of corn plants by phytopathogenic microorganisms of the Fusarium genus, in particular Fusarium pseudograminearum, Fusarium graminearum and Fusarium culmorum.

14. Use of a compound according to claim 13 wherein the phytopathogenic microorganism is Fusarium graminearum.

15. A method for growing corn plants comprising applying or treating corn plants or a propagation material thereof with a compound as defined in claim 1.
